(19) United States
(12) Patent Application Publication
(10) Pub. No.: US 2018/0105293 A1
(43) Pub. Date: Apr. 19, 2018

(54) Spacecraft carbon dioxide removal system

(71) Applicant: Bigelow Aerospace, LLC, North Las Vegas, NV (US)

(72) Inventors: Robert T. Bigelow, Las Vegas, NV (US); Colm Kelleher, Las Vegas, NV (US); Lorenzo Flores, Las Vegas, NV (US); Juan Plata, Las Vegas, NV (US); Jared Rugg, Las Vegas, NV (US); Derek Johnson, Las Vegas, NV (US); David Birchler, Las Vegas, NV (US); Daniel Krizan, Las Vegas, NV (US); Philip Fowler, Las Vegas, NV (US)

(73) Assignee: Multiple Assignments

(21) Appl. No.: 15/732,236

(22) Filed: Oct. 10, 2017

Related U.S. Application Data
(60) Provisional application No. 62/496,336, filed on Oct. 13, 2016.
(60) Provisional application No. 62/496,335, filed on Oct. 13, 2016.
(60) Provisional application No. 62/496,334, filed on Oct. 13, 2016.

(51) Int. Cl. B64G 1/48

(52) U.S. Cl. CPC B64G 1/48; B01J 20/18; B01D 2257/504

(57) ABSTRACT

A Carbon Dioxide Removal System is disclosed. The system can be directed to space applications. The system incorporates unique features that allow ease of maintenance and parts replacement while in space.

### RELATED APPLICATIONS

This application claims priority under 35 U.S.C. § 119 to U.S. Provisional Application Nos. 62/496,336 filed Oct. 13, 2016, 62/496,335 filed Oct. 13, 2016, and 62/496,334 filed Oct. 13, 2016, the contents of which are all incorporate herein by reference in their entirety.

### BACKGROUND OF THE INVENTION

### Field of the Invention

This invention relates to removal of Carbon Dioxide (CO₂) from air in an enclosed space. The invention is focused on applications in space, but some embodiments may have applications in submarines and other confined locations.

### Background Art

Human space flight makes unique demands on habitat environmental control design. An important part of this design is removal of CO₂ from a spacecraft cabin, since CO₂ concentration in the closed air circulation system in a spacecraft cabin quickly becomes toxic.

While various CO₂ systems have been deployed, they have proven to be difficult to maintain and often complex, requiring a proportionally large amount of system power and mass. Repair and replacement can require removing and replacing, in some instances, an entire CO₂ removal system.

What is needed is a system for removal of CO₂ from a closed environment such as a spacecraft that is easier to maintain and more cost effective for replacing components of the system.

### SUMMARY OF THE INVENTION

In one embodiment of the present invention, a desiccant assembly for use in a CO₂ removal system is disclosed. The desiccant assembly has a desiccant canister that has an inlet and an outlet. The desiccant canister contains a removable canister assembly that has a removable desiccant media, a removable dust filter; and a heater. There is also a zeolite assembly that receives air flow from a first desiccant assembly and directs the processed airflow to a second desiccant assembly. The zeolite assembly has a removable zeolite canister that has a zeolite media and a healer.

During operation of the CO₂ removal system the removable canister assembly resides within the desiccant canister and the desiccant canister is capable of operating in a first mode that receives air in the inlet and dries the air before proceeding to the outlet, in the second mode the outlet receives air with very low water and CO₂ levels and uses it to push any remaining water and CO₂ to the outlet of the system.

A second zeolite assembly and a third desiccant assembly can be incorporate in the system wherein one of the zeolite assemblies and one of the desiccant assemblies can be removed during operation of the system.

### BRIEF DESCRIPTION OF THE DRAWINGS

The invention is generally shown by way of reference to the accompanying drawings in which:

FIG. 1 is a diagram of an embodiment of the CO₂ removal system of the present invention;

FIG. 2 is a schematic of a vacuum butterfly valve; and

FIG. 3 is a schematic of a 3 port rotary valve.

### DETAILED DESCRIPTION OF THE INVENTION

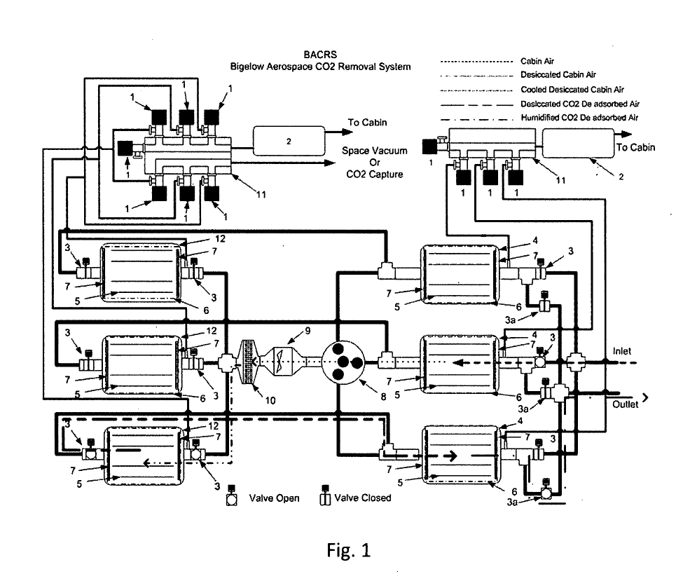

FIG. 1 shows an embodiment a CO₂ removal system of the present invention. Process air is tapped off downstream of a condensing heat exchanger with water capture device. Incoming air is rich in CO₂, saturated with water vapor, and as cold as possible. A series of broken lines and arrows in FIG. 1 indicate a sample path for the CO₂.

By opening one of a group of three butterfly valves (3) located on the inlets of media filled canisters (6) the incoming air is directed towards the canister with unsaturated media. This media is a combination of moisture adsorbing zeolite and silica gel in a desiccant canister (4). The desiccant canister (4) dries the process air. During adsorption, air is warmed up. The media filled canister (6) is removable. In one embodiment, there is a dust filter (7) in the path of the flow of the CO₂ in the removable canister. The air enters the canister through an inlet and exits the canister through an outlet.

The process air, drier and hotter, exits the desiccant canister (4) and is directed to the blower (9) by a rotary valve (8). A closed butterfly valve helps to keep the air flowing through the rotary valve (8). The blower (9) uses suction and pressure to move air through CO₂ removal system.

Compression of the process air further raises its temperature. The heat of adsorption and heat of compression must be removed from the air to maximize CO₂ performance. Adsorption media capacity increases as the media temperature decreases. Therefore, the air is cooled by a heat exchanger (10) downstream of the blower (9). At this point the process air is dry, cool, and CO₂ rich.

By opening one of a group of three butterfly valves (3) located on the inlets of media filled canisters (12) the incoming air is, again, directed towards the canister (12) with unsaturated media. The media in a zeolite canister (12) is solely carbon dioxide adsorbing zeolite. The zeolite canister (12) removes carbon dioxide (and whatever small amounts of water are left) from the process air. In one embodiment, there is a dust filter (7) in the path of the CO₂ flow in the zeolite canister (12).

The air is pushed through an open outlet butterfly valve on the canister (12) and to the outlet of a saturated desiccant canister (4). With the removal of water and carbon dioxide from the process air stream the adsorption process is complete at this point. In this regard the desiccant canister has a first mode of operation where air passes from the inlet toward the outlet and a second mode of operation where air passes from the outlet toward the inlet. Inherently there is a third mode that has not airflow except to reject the air that is inside along with what is being removed (water for desiccant, CO₂ for zeolite).

From this point in the system onwards the process air will be used to regenerate saturated media. A closed rotary valve path forces all air to flow through the desiccant canister in the direction opposite adsorption. The dry air pulls water from the saturated media as it blows through. The air exiting the desiccant canister is wetter than the air entering the canister. Additionally, this air flow helps to cool the media. Prior to this blow through the media was heated with embedded heaters (5). Heating the media helps desorption because as the temperature of the media increases its capacity decreases. By opening one of a group of three butterfly valves (3) or check valves (3a) the air is directed out of the system. This moist, CO₂ poor air is injected back at the outlet of the condensing heat exchanger and water capture device.

Desiccant regeneration can be further aided with an additional phase. Prior to the blow-through phase and following saturation a pump can be used to evacuate the moist air generated by heating the canister. Routing and selection of the purged canister is accomplished with a manifold (11) and solenoids (1), respectively. The canister is isolated from the system by the rotary valve and several closed butterfly valves. This phase is additional and helps to reduce the regeneration load placed on the blow-through phase. In keeping with one aspect of the invention and as disclosed, it is possible to replace canister inserts during this phase instead of regenerating if the media is spent.

The regeneration process for the zeolite canister (12) differs from the desiccant canister (4). It is simpler. Immediately after media saturation, the butterfly valves on the inlet and outlet of the zeolite canister close, thus isolating the media. Embedded heaters (5) heat the media while a pump (2) removes air from the zeolite canister (12) through a tap off at the canister's inlet. This air save process is used to ensure no air is exhausted into space. This air is ducted back into the cabin.

One of a set of vacuum rated solenoid valves (1) opens to select the regenerating canister. Once all air has been removed from the zeolite canister the solenoid valve is closed and the pump is turned off.

One of a separate set of vacuum rated solenoid valves (1) opens to expose the same regenerating canister to space vacuum (or a CO₂ capture system's vacuum pump). The vacuum lowers the partial pressure of CO₂ in the canister and exhausts released carbon dioxide. Following regeneration the zeolite canister enters a standby state where it is completely isolated from the system. All associated solenoids and butterfly valves are closed.

The use of a system with multiple canisters comprised of a combination of desiccant and Zeolite canisters allows for the ability to maintain functionality even if one system is inoperable. The number of desiccant and Zeolite canister can be determined according to variables such as mission profile and duration. In the preferred embodiment, there are three desiccant canisters and three Zeolite canisters.

System operating variables such as heater (5) timing, CO₂ flow rate, outlet to cabin or space or CO₂ capture, and choice of canisters to operate to name just a few variables can be determined based upon factors such as environmental CO₂ levels, canister utilization, and condition of the air to name just a few factors.

One aspect of the present invention is that each of the six media canisters was designed for ease of maintenance and rapid replacement while in orbit or in deep space. The ability to remove the insert (internal media and regeneration system) within minutes is a design feature for deep space CO₂ removal systems because it allows for easy maintenance of each separate canister in the system. As disclosed, canisters in this mode can be swapped out without shutting down the system. Each canister insert comprises a novel self-contained package of media, filtration, and heater plates. This allows significant increase in on orbit maintenance efficiency and is a fundamental improvement over the International Space Station CO₂ removal system which mandates time consuming removal of the entire system from the International Standard Payload Rack to accomplish changing regenerable beds.

Furthermore, launch costs for replacement mediums, heaters, and filters is lower than for deploying an entire canister or an entire CO₂ removal system to a deployed spacecraft.

Another aspect of the present invention is to reduce complexity in the directional flow of the air through the CO₂ removal system through a four-port rotary valve that has been designed, manufactured and successfully tested. The rotary valve comprises one inlet port and three outlet ports. This is a low friction designed valve allowing the use of a very small drive motor. The internal seals are designed for low leakage. In one embodiment, the valve itself is of a relatively large diameter (˜1.5 inches) and designed to be used in a gaseous environment.

Another aspect of the present invention is the use of vacuum rated butterfly valves. Vacuum rated butterfly valves are ubiquitous among vacuum component suppliers. All suppliers have their versions of this manually operated valve. These valves feature a nearly uninhibited flow path when open, simplistic design, and low cost. Their simplistic design allows for ease of maintenance. In an environment where they are exposed to a lot of dust this allows for easy cleanup or replacement of the seal that will help extend the lifetime of the valve. This simple manual valve was combined with an electrically driven actuator to create an electrically controllable vacuum rated butterfly valve. The design works with either a rotary solenoid, brushed DC motor, or brushless DC motor. By combining the motor power leads with an H bridge circuit, the valve can be actuated in either direction with no rewiring. The H bridge circuit enables voltage to be applied across the actuator load in either direction.

Temperature swing desorption and pressure swing desorption are two established methods for regeneration of molecular sieve media beds. Another aspect of the present invention is the use of a combination of both methods. During temperature swing desorption the temperature of the media is raised. The capacity of media to retain adsorbed molecules decreases as temperature increases and captured molecules are released. During pressure swing desorption the pressure around the media is reduced. The capacity of media to retain adsorbed molecules decreases as pressure decreases and captured molecules are released. In spacecraft applications adsorption is used to capture CO₂ molecules and, thereby, filter the air. It is also used to capture water molecules and protect them from exhausting to the vacuum of space. This CO₂ adsorbing media is regenerated through temperature and pressure swing desorption. However, the water adsorbing media is only regenerated through temperature swing desorption. A combination of temperature and pressure swing desorption has never been used in space to regenerate moisture adsorbing media, or desiccant. In one embodiment of operation, the CO₂ removal system accomplishes this. The system uses heaters embedded in the desiccant media to raise its temperature. At the same time a pump lowers the pressure of the air around the media and exhausts desorbed water vapor. This regeneration approach is novel among space applications. As disclosed in general above, adsorbing materials can be expanded to any type of sorbent that can be regenerated through temperature or pressure swing desorption.

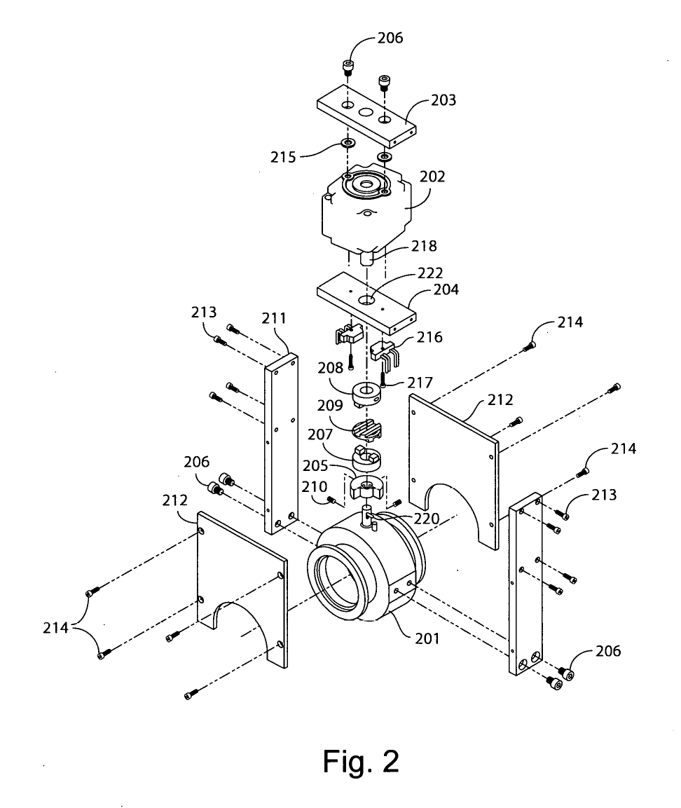

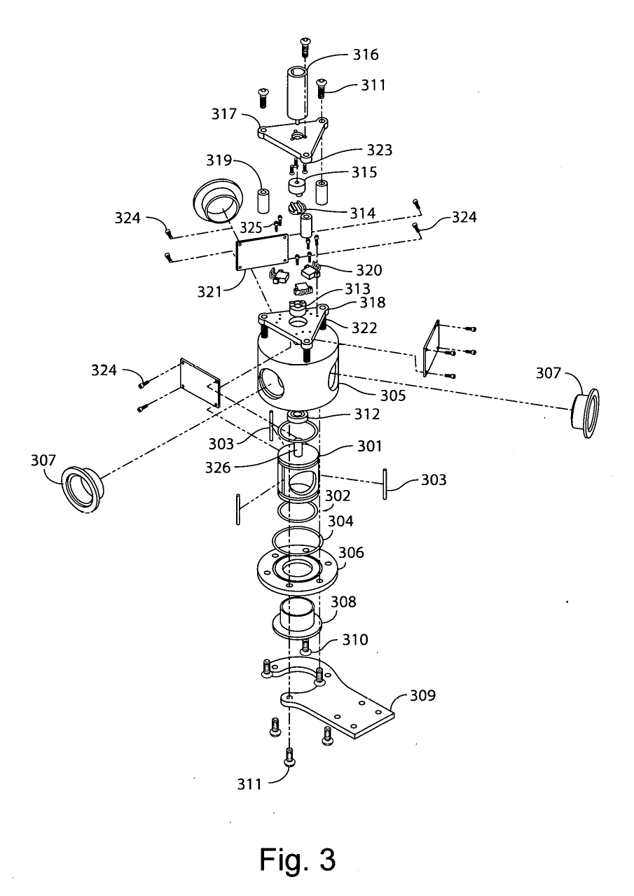

FIG. 2 is the schematic of the preferred embodiment of a vacuum butterfly valve as identified as in FIG. 1 as vacuum butterfly valve (3). The vacuum butterfly valve of FIG. 3 has a top actuator plate (203) secured to a rotary solenoid (202) with socket head cap screws (206) and flat washers (215). The top actuator plate (203) also is attached to two side brackets (211) with socket head cap screws (213). The rotary solenoid has a shaft (218) that extends through and opening (222) in a bottom actuator plate (204). The bottom actuator plate (204) is attached to two infrared reflective sensors (216) that are secured to the bottom actuator plate (204) with socket head cap screws (217). The shaft (218) extend into a set screw hub (218) that is seated in an acetal disc (209). The acetal disc (209) is in contact with a set screw hub (207) that contacts a rotary restrictor (205). The rotary restrictor (205) is secured to a valve shaft (220) using socket set screws (210). The valve shaft (220) is secured to a disc within the butterfly valve (201). The two side brackets are attached to the butterfly valve (201) with socket heat cap screws (206) and the bottom actuator plate (204) with socket head cap screws (213). There are two coupling housings (212) that each connect to each side bracket (211) using socket head cap screws (214). The rotary solenoid (202) can be activated to rotate the shaft (218) and through that rotation the valve shaft (220) to turn the butterfly valve from a closed position to an open position or any degree in between. Inherent to butterfly valves is a rotating disc that operates when the valve is closed in conjunction with corresponding structures in the valve body to restrict passage of air and when opened allows for the passage of air. Also inherent to such valve discs are seals that increase the efficiency of restricting air flow in the valve closed position. In the closed position, the seals are situated between the disc and the corresponding structures in the valve body. Such valves on the market are designed for the seals to be replaced on the disc without replacing the entire butterfly valve assembly. In a deployed spacecraft this allows for the replacement of just the seals and does not require the replacement of the heavier and bulkier valve assembly. The space application of such valves has not been done before.

FIG. 3 is a preferred embodiment of a rotary valve that was identified in In FIG. 1 as rotary valve (8). In the preferred embodiment, the rotary valve has three ports and each port corresponds to a flange (307) seated in the valve housing (305). There is a motor (316) attached to an actuator mounting plate (317) using flathead socket cap screws (323). The actuator mounting plate (317) is connected to an actuator base plate (318) through application of button head cap screws (311) and round standoffs (319). The motor (316) cooperates with a slotted disc flat shaft coupling clamp (315) that is in contact with an acetal disc (314) and the acetal disc (314) contacts a slotted disc flex shaft coupling clamp (313). There are three reflective switches (320) connected to the actuatot base plate (318). The actuator base plate (318) is connected to the valve housing with set screws (322). There are three actuator mounting walls (321) attached to the actuator mounting plate (317) and actuator base plate (318) by socket head cap screws (324). There is a ball bearing (312) for receiving a shaft (301) that is part of an assembly (301). The assembly (301) has O-ring stock (303) and o-rings (302) and (304). The assembly (301) and the o-rings and o-ring stock fits within the housing (305). An outlet (306) is attached to the housing (305). A flange (308) connects to the outlet (306) and a mounting bracket (309) along with button head cap screws (311) secures the outlet to the housing (305). Rotation of the assembly (301) directs the path of the gas as between the outlet (306) and the three ports.

System operating variables such as CO₂ flow rate, choice of desiccant canister for use, to name just a few variables can be determined based upon factors such as environmental CO₂ levels, canister utilization, and condition of the air to name just a few factors for determining the positioning of assembly (301) to choose a flow path.

While embodiments have been described in detail, it should be appreciated that various modifications and/or variations may be made without departing from the scope or spirit of the invention. In this regard it is important to note that practicing the invention is not limited to the applications described herein. Many other applications and/or alterations may be utilized provided that such other applications and/or alterations do not depart from the intended purpose of the invention. Also, features illustrated or described as part of one embodiment may be used in another embodiment to provide yet another embodiment such that the features are not limited to the embodiments described herein. Thus, it is intended that the invention cover all such embodiments and variations. Nothing in this disclosure is intended to limit the scope of the invention in any way.

What is claimed is:

1. A desiccant assembly for use in a CO₂ removal system, the assembly comprising:
a desiccant canister having an inlet and an outlet;
a removable canister assembly within the desiccant canister and the removable canister assembly comprising;
i. a removable desiccant media;
ii. a removable dust filter; and
iii. a heater;
wherein, during operation of the CO₂ removal system the removable canister assembly resides within the desiccant canister and the desiccant canister capable of operating in a first mode that receives air in the inlet and generally dries the air before the air proceeds to the outlet and in the second mode the outlet receives air having water and CO₂ substantially removed from the input air and the inlet directs the air having water and CO₂ substantially removed to a desired location.

2. A CO₂ removal system comprising;
a first and second desiccant canisters each having an inlet and an outlet and a butterfly valve disposed on each inlet and each desiccant canister having a first and second mode of operation and in the first mode of operation air enters the inlet of a desiccant canister and travels toward the outlet and in the second mode of operation air enters the outlet and travels toward the inlet and each desiccant canister having a removable canister assembly comprising a removable desiccant media and a heater;
a zeolite canister and the zeolite canister having an inlet and a butterfly valve disposed on the inlet and a butterfly valve disposed on the outlet each zeolite canister having a removable canister assembly comprising a removable zeolite media and a heater;
a rotary valve in cooperation with the outlets of the desiccant canisters and the rotary valve for choosing which desiccant canister air flow proceeds to a zeolite canister;
an air blower that draws the air from the rotary valve; and
a heat exchanger that receives the air flow from the air blower and passes the air flow to a butterfly valve on the inlet of the zeolite canister and the air passes through the zeolite canister to a butterfly valve on the outlet of the zeolite canister then to the outlet of a desiccant canister and the desiccant canister operating in the second mode;
wherein, the inlet butterfly valves on the desiccant containers are set such that only the first desiccant container receives an air flow in the inlet and the air flow passes through the first desiccant container to a rotary valve that is set to direct only the first desiccant container air flow toward a blower, and the blower directs the air flow to a heat exchanger that directs the air flow to the inlet of the zeolite canister and the air flow passes through the zeolite canister and is directed to the outlet of the desiccant canister and the air flow passes through the desiccant canister to the inlet and from the inlet to a desired location.

3. A zeolite assembly for use in a CO₂ removal system, the assembly comprising:
a zeolite canister having an inlet and an outlet;
a removable canister assembly within the zeolite canister and the removable canister assembly comprising;
i. a removable zeolite media;
ii. a removable dust filter; and
iii. a heater;
wherein, during operation of the CO₂ removal system the removable canister assembly resides within the zeolite canister and the zeolite canister capable of receiving air in the inlet and generally dries the air before the air proceeds to the outlet.

4. An adsorbing assembly for use in a CO₂ removal system, the assembly comprising:
an adsorbing canister having an inlet and an outlet;
a removable canister assembly within the adsorbing canister and the removable canister assembly comprising;
i. a removable adsorbing media;
ii. a removable dust filter; and
iii. a heater;
wherein, during operation of the CO₂ removal system the removable canister assembly resides within the adsorbing canister and the adsorbing canister capable of receiving air in the inlet and generally dries the air before the air proceeds to the outlet.

5. A CO₂ removal system comprising;
three desiccant canisters each having an inlet and an outlet and a butterfly valve disposed on each inlet and each desiccant canister having a removable canister assembly housing a desiccant media and a heater and having a first and second mode of operation and in the first mode of operation air enters the inlet of a desiccant canister and travels toward the outlet and in the second mode of operation air enters the outlet and travels toward the inlet;
three zeolite canisters and each zeolite canister having an inlet and a butterfly valve disposed on the inlet and an outlet and each zeolite canister having and a butterfly valve disposed on the outlet and each zeolite canister having a removable canister assembly comprising a removable desiccant media and a heater;
a rotary valve in cooperation with the outlets of the three desiccant canisters and the rotary valve for choosing which one of the three desiccant canister air flow proceeds to a zeolite canister;
an air blower that draws the air from the rotary valve; and
a heat exchanger that receives the air flow from the air blower and passes the air flow to a butterfly valve on the inlet of each of the zeolite canisters;
means for directing air flow through one of the three desiccant canisters to the rotary valve and blocking air flow from the remaining two desiccant canisters;
means for directing the air flow through the rotary valve through the heat exchanger;
means for directing the air flow from the heat exchanger through one of the three inlet butterfly valves of the zeolite canisters;
means for directing the air flow through the outlet butterfly valve of the one zeolite canister where the air flowed through an zeolite canister inlet butterfly valve;
means for directing the air flow from the outlet butterfly valve of the one zeolite canister where the air flowed through the zeolite canister inlet butterfly valve, to the outlet of one of the two desiccant canisters that the rotary valve blocked air flow toward the heat exchanger; and
means for directing the air flow from the outlet of one of the desiccant canisters to a desired location;
wherein, during operation two desiccant canisters and one of the zeolite canister are in operation thereby allowing maintenance on the remaining desiccant canister and the remaining two zeolite canisters, while the system continues to remove CO₂ from the air.

6. A CO₂ removal system comprising;
a first, second, and third desiccant assembly each having an inlet and an outlet and each desiccant assembly having a desiccant canister and each desiccant canister having a removable canister assembly comprising a removable desiccant media and a heater;
a first, second, and third zeolite assembly and each zeolite canister having an inlet and an outlet and each zeolite assembly having a zeolite canister and each zeolite canister having a removable canister assembly comprising a removable zeolite media and a heater;
a rotary valve;
an air blower; and
a heat exchanger;
means for directing air flow through the first desiccant canister to the rotary valve;
means for directing the air flow of the first desiccant canister through the rotary valve then through the heat exchanger;
means for directing the air flow from the heat exchanger through the first zeolite canister;
means for directing the air flow through the outlet of the first zeolite canister;
means for directing the air flow from the outlet of the first zeolite canister to the outlet of the second desiccant canister; and
means for directing the air flow from the outlet of the second desiccant canister through the second desiccant canister to the inlet of the second desiccant canister;
wherein, during operation the first and second desiccant canisters and the first zeolite canister are in operation thereby allowing maintenance on the third desiccant canister and the second and third zeolite canisters, while the system continues to remove CO₂ from the air.

7. A process for repairing a butterfly valve connected to an adsorbing canister as part of a CO₂ removal system in outer space or on an extraterrestrial mass the process comprising the steps of:
disconnecting an adsorbing canister from a butterfly valve;
removing a seal from a rotating disc in the body of the butterfly valve;
replacing a seal onto the rotating disc in the body of the butterfly valve; and
reconnecting the adsorbing canister to the butterfly valve.

8. A process for removing and replacing an adsorbing media that is part of an adsorbing assembly incorporated in a CO₂ removal system in a spacecraft, the process comprising the steps of;
disconnecting an adsorbing assembly from a CO₂ removal system;
opening an adsorbing canister that is part of the adsorbing assembly to access a removable adsorbing canister disposed within the adsorbing canister;
removing the removable adsorbing canister;
accessing an adsorbing media disposed within the removable adsorbing canister;
removing the adsorbing media from the removable adsorbing canister;
replacing the adsorbing media removed from the removable adsorbing canister with another adsorbing media inserted into the removable adsorbing canister;
inserting the removable adsorbing canister into the adsorbing canister; and
reconnecting the adsorbing canister to the CO₂ removal system.

9. A process for repairing a butterfly valve connected to an adsorbing canister as part of a CO₂ removal system, the process comprising the steps of:
disconnecting an adsorbing canister from a butterfly valve;
removing a seal from a rotating disc in the body of the butterfly valve;
replacing a seal onto the rotating disc in the body of the butterfly valve; and
reconnecting the adsorbing canister to the butterfly valve.

10. A CO₂ removal system comprising;
a first, second, and third desiccant assembly each having an inlet and an outlet and each having a desiccant canister and each desiccant canister having a removable canister assembly comprising a removable desiccant media and a heater;
a first and a second zeolite assembly and each zeolite assembly having an inlet and an outlet and each having a zeolite canister each zeolite canister having a removable canister assembly comprising a removable zeolite media and a heater;
a rotary valve;
an air blower; and
a heat exchanger;
means for directing air flow through the first desiccant canister to the rotary valve;
means for directing the air flow of the first desiccant canister through the rotary valve then through the heat exchanger;
means for directing the air flow from the heat exchanger through the first zeolite canister;
means for directing the air flow through the outlet of the first zeolite canister;
means for directing the air flow from the outlet of the first zeolite canister to the outlet of the second desiccant canister; and
means for directing the air flow from the outlet of the second desiccant canister through the second desiccant canister to the inlet of the second desiccant canister;
wherein, during operation the first and second desiccant canisters and the first zeolite canister are in operation thereby allowing maintenance on the third desiccant canister and the second zeolite canisters, while the system continues to remove CO₂ from the air.
